(19) United States
(12) Patent Application Publication
(10) Pub. No.: US 2011/0290330 A1
(43) Pub. Date: Dec. 1, 2011

(54) FLUID FLOW CONTROL IN A MICROFLUIDIC DEVICE

(75) Inventors: Marcus Gassmann, Waldbronn (DE); Fritz Bek, Waldbronn (DE)

(73) Assignee: AGILENT TECHNOLOGIES, INC., Santa Clara, CA (US)

(21) Appl. No.: 12/672,653

(22) PCT Filed: Aug. 9, 2007
(86) PCT No.: PCT/EP07/58283

§ 371 Date: Feb. 8, 2010

(51) Int. Cl. F15D 1/00

(52) U.S. Cl. 137/14

(57) ABSTRACT

A method for removing fluid in a microfluidic device, the microfluidic device having a fluid channel, a first well, and a second well, the first well and the second well being coupled to a first end of the fluid channel, the method including applying a pressure difference between the second well and the first well, and applying a pressure difference between the first end and a second end of the fluid channel being below a certain threshold, for at least partly removing a first fluid from a first supply line coupled between the first well and the first end of the fluid channel.

This application is the National Stage of International Application No. PCT/EP2007/058283, filed on 9 Aug. 2007 which designated the United States of America, and which international application was published as Publication No. WO 2009/018861.

### BACKGROUND

The present invention relates to operating microfluidic devices.

In sample analysis systems, e.g. in separation systems such as liquid chromatography and capillary electrophoresis systems, small dimensions generally result in improved analysis efficiency due to time saving based on short residence times in the system and small consumption of fluids.

In microstructure technology applications as in the Agilent 2100 Bioanalyzer, by the applicant Agilent Technologies, fluid may be conveyed through miniaturized channels (which may be filled with a sieving material) as part of a microfluidic chip or substrate, often being referred to as so-called Lab Chip or Lab-on-a-Chip. Such microfluidic device might integrate multiple laboratory functions on a single fluidic microstructure device capable of handling extremely small fluid volumes down to less than picoliters.

Such functions might comprise capillary electrophoresis as an example for a microstructure technology application, wherein an electric field is generated in the fluid channels in order to allow for a transport of compounds of the fluid through the channels using electric forces. Such an electric force or field may be generated by contacting pins of the capillary electrophoresis device into the fluid which may be filled in a well defined by a carrier element coupled to a microfluidic chip, and by applying an electrical voltage to such contact pins.

### SUMMARY

It is an object of the invention to provide an improved operation of a microfluidic device. The object is solved by the independent claims. Preferred embodiments are shown by the dependent claims.

According to the present invention, a method is provided for removing fluid in a microfluidic device. The microfluidic device comprises a fluid channel, a first well, and a second well. The first well and the second well are coupled to a first end of the fluid channel. For at least partly removing a first fluid from a first supply line coupled between the first well and the first end of the fluid channel, a pressure difference is applied between the second well and the first well, and a pressure difference is applied between the first end and a second end of the fluid channel being below a certain threshold,

In embodiments of the invention, the fluid channel is adapted to be at least partly exposed to a magnetic field to force at least a portion of a first fluid being receptive to a magnetic field and being driven into the fluid channel to retain in the fluid channel.

In an embodiment, the magnetic field is applied to at least a part of the fluid channel to force the first fluid or the portion of the first fluid to retain in the fluid channel against external pressure forces.

According to embodiments of the invention, the microfluidic device further comprises a plurality of wells and a plurality of supply lines each fluidly coupling the wells with either a first end of the fluid channel or a second end of the fluid channel.

In an embodiment, the first fluid is driven from the first well through the fluid channel to a second well previously to applying the magnetic field to the fluid channel for locking or retaining the first fluid within the fluid channel.

In an embodiment, the first fluid might comprise so-called magnetic particles or beads. Such beads might be realized as ferric or ferric-oxide micro particles (e.g. having a diameter of about 100 to 5000 nm (nanometer). The beads can exhibit a functionalized surface coating to which several types of molecules can be coupled. Typically these surface-coupled molecules are intended to bind and “capture” a specific sample fraction within complex biological samples. These capture molecules might be antibodies or aptamers (for binding of specific proteins), an Oligo-dT-tail (for mRNA isolation) or oligonucleotides (for sequence-specific capturing of specific DNA or RNA strands). The magnetic beads can also be in suspension with non-magnetic beads comprising said reagent (so-called functional beads).

The magnetic field causes a mechanical force to magnetic or magnetizable material. Such material might be regarded as comprising a large number of magnetic dipoles. The physical cause of the magnetism is the atomic magnetic dipole. Magnetic dipoles, or magnetic moments, predominantly result from a quantum mechanical property called the spin dipole magnetic moment. When the spins interact with each other in such a way that the spins align and the influence of a magnetic field, the material is called magnetic or usually more specifically ferromagnetic. Further, e.g. so-called ferrimagnetic materials exist, in which the magnetic moment of the atoms on different sub lattices are opposed. From a macroscopic view, ferrimagnetic materials show similar behavior compared to ferromagnetic materials.

Under an influence of the magnetic field, the magnetic particles or beads of the first fluid get similarly orientated, so that they concatenate with each other to a certain degree, thus being prevented from being washed away, if being exposed to fluid pressure (e.g. caused by driving a further through the fluid channel). In other words, the beads will “clump” together, if the magnetic field is applied, therewith forming a fluid filter with respect to further fluids being driven through the fluid channel.

In an embodiment, the magnetic field is applied to a distinct location of the chip, e.g. to a second or exit end of the fluid channel. This allows for retaining the first fluid against further fluids being processed in direction from the first end to the second end of the fluid channel.

In an embodiment, magnetic fields are applied to each distinct locations of the chip, e.g. to the first end or entry end of the fluid channel and the second end or exit end of the fluid channel, i.e. to those points that are each coupled with corresponding supply lines. This allows for retaining the first fluid along the whole length of the fluid channel in both flow directions. The magnetic field might be generated by applying a certain current to electromagnetic elements, e.g. realized as electric coils being each positioned close to one of the end points of the fluid channel. Alternatively, permanent magnets might be provided to be movable such that the magnetic field will be provided, if the magnets are moved to certain positions.

In an embodiment, after the fluid channel is partially or completely filled-up with the first fluid, the corresponding wells might be decoupled from the first pressure potential difference. For subsequently removing the first fluid from the supply lines, a second pressure potential difference is applied between a third well and the first well, and a third pressure potential difference is applied between a fourth well and the second well, wherein the third well and the fourth well are filled with gas, preferably air. The gas displaces the first fluid from the corresponding supply lines, as soon as the pressure applied exceeds a certain threshold being dependent of the characteristics of the first fluid (viscosity), from the inner diameter of the supply lines and the characteristics of the inner surfaces of the supply lines. After emptying the supply lines, the first fluid is still present in the first channel.

In an embodiment, a pressure potential difference between two wells is generated by applying a positive pressure with respect to the ambient pressure to one of these wells and/or a negative pressure with respect to the ambient pressure to the other one of these wells. Therewith, the first pressure potential difference might be generated by applying a positive pressure to the first well and/or a negative pressure to the second well. The second pressure potential difference might be generated by applying a positive pressure to the third well and/or a negative pressure to the first well. Correspondingly, the third pressure potential difference might be generated by applying a positive pressure to the fourth well and/or a negative pressure to the second well.

In a further embodiment, a hydrophobic coating is provided that covers all or parts of the inner surface of the supply lines with respect to the fluids. The hydrophobic coating prevents a (polar) fluid from flowing along the supply lines unless a pressure potential difference is applied above a certain threshold. Thus, the hydrophobic coating provides a fluidic barrier having a valve-like behavior.

In a further embodiment, a hydrophilic coating is provided that covers all or parts of the inner surface of the fluid channel. The hydrophilic coating allows a fluid flowing through the fluid channel and being kept therein without applying a pressure potential difference.

In a further embodiment, an analysis apparatus is provided for analyzing biological material such as DNA, RNA, proteins and cells, comprising a reception for removably inserting the microfluidic device. The analysis apparatus comprises a pressure source, a pressure control unit and pressure supply lines coupling the pressure source with each one of the wells of the microfluidic device. The pressure control unit is coupled to the pressure source by means of a control line for controlling the pressure source for selectively applying pressure potential differences to a plurality of pairs of wells of the microfluidic device. In particular, the pressure control unit controls applying the first pressure potential difference between the first well and the second well for driving the fluid from the first well through the fluid channel to the second well, and subsequently the second pressure potential difference and the third pressure for removing the first fluid from the supply lines.

In a further embodiment, a sequence of flows of different fluids is provided. Therein, after the first fluid is being driven into the fluid channel as described above, the first fluid is locked within the fluid channel by applying the magnetic field. Now a sequence of further different fluids might be driven through the fluid channel comprising the locked functionalized beads. All the fluids might be kept physically separated in different wells. After a processing of each further fluid, the supply lines might be emptied by applying appropriate pressure potential differences corresponding to the second and third pressure potential difference. Therewith, no mixture of the different fluid will occur outside the fluid channel. After having processed the plurality of further fluids, the magnetic field might be switched off, so that the fluid channel can be emptied from the remaining fluid, e.g. the first fluid, being captured in the fluid channel.

In an embodiment thereto, a second fluid or a sample fluid is processed to flow through the fluid channel. The second fluid interacts with the first fluid such that a first fraction comprising a certain compound of the second fluid is bound by the functional beads of the first fluid being captured within the fluid channel by the magnetic force, while the remaining fraction of the fluid might with unwanted compounds passes the fluid channel, e.g. flowing to one of the wells acting as a common waste.

In a further embodiment to processing a plurality of fluids, a third fluid or wash fluid is processed to flow towards the fluid channel, wherein the third fluid is chosen to wash further unwanted compounds still being present in first fraction of the second fluid being present in the fluid channel, e.g. unwanted compounds being bound to desired compounds of the first fraction of the second fluid. The wash fluid might be water or an alkaline fluid, e.g. having a pH value of 9 or 10. Alternatively, a saline solution might be chosen as a wash fluid.

In a further embodiment to processing a plurality of fluids, a fourth fluid is processed to elute the desired compounds being bound by the functional beads, e.g. flowing into a target well.

While the concentration of the desired compound within the original sample fluid (second fluid) might be rather low, the described process can be used to achieve an increase of the compound concentration in the eluted sample. After capturing the complete compound fraction from the whole sample volume this fraction can be eluted in a much smaller elution volume and therefore showing an increased compound concentration. Further, this process allows for generating a purified solution of the desired compound.

Embodiments of the invention can be partly or entirely embodied or supported by one or more suitable software programs, which can be stored on or otherwise provided by any kind of data carrier, and which might be executed in or by any suitable data processing unit.

### BRIEF DESCRIPTION OF DRAWINGS

Other objects and many of the attendant advantages of embodiments of the present invention will be readily appreciated and become better understood by reference to the following more detailed description of preferred embodiments in connection with the accompanied drawings. Features that are substantially or functionally equal or similar will be referred to with the same reference signs. The Figures show:

FIG. 1 a schematic block diagram of a microfluidic device,

FIG. 2 a section of schematic block diagram of the microfluidic device of FIG. 1 illustrating pressure potential differences and corresponding fluidic flows, and

FIG. 3 shows an analyzing apparatus with a microfluidic device of FIG. 1.

### DETAILED DESCRIPTION

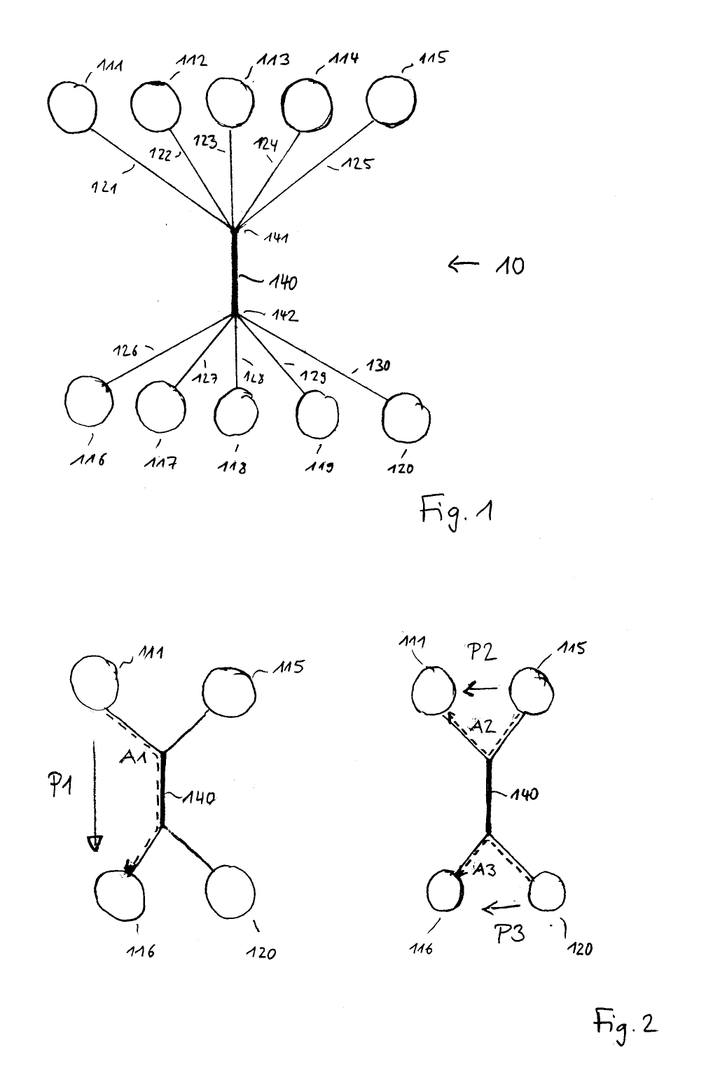

Referring to FIG. 1, a microfluidic device 10 is shown, the microfluidic device 10 having a planar geometry with a plurality of wells 111-120, a fluid channel 140, and a plurality of channel supply lines 121-130, wherein by way of example five wells 111-115 are coupled via each one of the supply lines supply lines 121- 125 to a first end or channel entry 141 of the fluid channel 140, and another five wells 116-120 are coupled via each one of the supply lines supply lines 126-130 to a second end or channel exit 142 of the fluid channel 140. The supply lines might have an inner diameter between 50 and 1000 micrometer, the fluid channel might have a length of 5 to 200 millimeter and a diameter/cross section of 50 to 1000 micrometer, and the well might have a fluid capacity of 0.1 to 500 microliters.

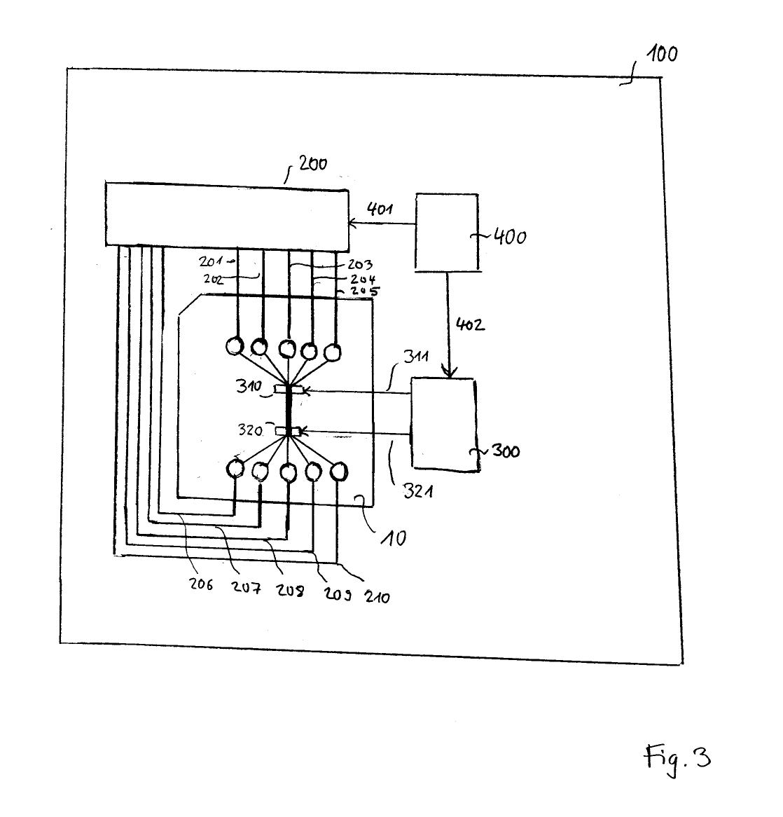

By way of example, the first well 111 is adapted for receiving a first fluid that comprises functional beads, the first fluid also being referred to as functional fluid. The second well 112 is adapted for receiving a second fluid to be analyzed, also being referred to as sample fluid. The third well 113 is adapted for receiving a third fluid, also being referred to as wash fluid. The fourth well 114 is adapted for receiving a fourth fluid, also being referred to as elution fluid. The fifth well 115 and the tenth well 120 are filled with gas, e.g. air. Further, by way of example, the sixth well 116 acts as a waste for collecting parts of fluids being driven through the fluid channel 140 that are not further used. The wells are adapted to be coupled to a pressure source e.g. provided by an analyzer being described under FIG. 3. The pressure source provides a sequence of pressure potential differences each to selected pairs of wells, so that the fluids of different wells will flow one after the other through the fluid channel 140. In order to clean or empty supply lines from one fluid before another fluid is processed, further pressure potential difference might be applied to pairs of wells each including one of the air-filled wells as being exemplarily described under FIG. 2.

In an embodiment, a hydrophobic coating is provided that covers all or parts of the inner surface of the supply lines 121-130. The hydrophobic coating prevents a fluid from flowing along the supply lines due to the hydrodynamic barrier imposed by the hydrophobic surface, unless a pressure potential difference exceeding a certain threshold is applied. Further, a hydrophilic coating might be provided that covers all or parts of the inner surface of the fluid channel 140. The hydrophilic coating of the fluid channel provides retaining a fluid being driven into the fluid channel 140 within said channel unless a certain pressure potential difference is applied.

The microfluidic device might be realized as a glass or plastic chip or as a hybrid consisting of multiple materials

Referring now to FIG. 2, FIG. 2 shows a section of FIG. 1 with the first well 111, the fifth well 115, the sixth well 116 and the tenth well 120 being coupled to the fluid channel 140 over the corresponding supply lines. The first well comprises the first fluid and the fifth well 115 and the tenth well 120 are filled with air. The sixth well acts as waste as described above. Further, on the left side, a first full arrow P1 is shown being directed from the first well 111 toward the sixth well 116 that symbolizes a first pressure potential difference P1, in the following also being referred to as pressure difference P1 applied between the first and sixth well. Correspondingly, a first dotted arrow A1 symbolizes a flow of the first fluid from the first well 111 via the fluid channel 140 versus the sixth well 116. On the right side, a second full arrow P2 directed from the fifth well 115 towards the first well 111 symbolizes a second pressure difference P2 applied between the fifth and first well. Correspondingly, a second dotted arrow A2 symbolizes a flow of air contained in the fifth well 115 versus the first well 111. Further, a third full arrow P3 is shown being directed from the tenth well 120 towards the sixth well 116, symbolizing a third pressure difference P3 applied between tenth and sixth well. Correspondingly, a third dotted arrow A3 symbolizes a flow of air contained in the tenth well versus the sixth well 116.

The pressure potential differences P1-P3 might be applied in the following sequence:

In a first step (referring to the left side of FIG. 2), the first pressure difference P1 is applied. If the first pressure difference P1 exceeds a certain pressure, the first fluid will start flowing from the first well 111 towards the fluid channel 140. This threshold is dependent e.g. from the characteristics of the fluids (viscosity), from the inner diameter and the lengths of the supply lines and the fluid channel and the characteristics of the inner surfaces of these elements. After the fluid channel is completely filled-up with the first fluid, the first well and fifth well are disconnected from pressure. In an embodiment, the first fluid is a functional fluid comprising magnetic beads having a surface with a reagent as described above with or reagent beads being suspended with magnetic beads.

In a second step (referring to the right side of FIG. 2), the second pressure difference P2 and the third pressure difference P3 are applied preferably simultaneously. The air of the fifth well 115 moves the first fluid left over in the first supply line 121 back into the first well 111, and the air of the tenth well 120 moves the first fluid left over in the sixth supply line 126 to the waste 116. Both pressure differences P2 and P3 are switched-off preferably simultaneously, so that the pressure difference between the entry point 141 and the exit point 141 of the fluid channel 140 is zero or at least below a certain threshold at any time during this step. The first fluid within the fluid channel 140 is thus retained within the fluid channel 140, being ready for further processing as being described in details under FIG. 3.

In an embodiment, a pressure difference between two wells is generated by applying a positive pressure with respect to the ambient pressure to one of these wells and a negative pressure with respect to the ambient pressure to the other one of these wells. Therewith, the first pressure difference might be generated by applying a positive pressure to the first well 111 and a negative pressure to the sixth well 116. The second pressure difference might be generated by applying a positive pressure to the fifth well 115 and a negative pressure to the first well 111. Correspondingly, the third pressure difference might be generated by applying a positive pressure to the tenth well 120 and a negative pressure to the sixth well 116.

FIG. 3 shows an analyzer 100 for analyzing a fluid, comprising a reception for removably inserting the microfluidic device 10 of FIG. 1. The apparatus 100 further comprises a pressure source 200, a current supply circuit 300, two electromagnets 310 and 320, and a control unit 400. The pressure source 200 is coupled via a plurality of pressure supply lines 201-210 to each one of the wells 111-120 of the inserted microfluidic device 10. The electromagnets, e.g. being realized as electrical coils, are located in close vicinity to the channel entry 141 and the channel exit 142 respectively of the inserted microfluidic device 10. The current supply circuit 300 is electrically coupled over a first current supply line 311 to the first electromagnet 310, and over a second current supply line 331 to the second electromagnet 320. The control unit 400 is coupled over a first control line 401 to the pressure source 200 and over a second control line 402 to the current supply circuit 300.

The pressure source 200 is adapted for selectively applying pressure differences to a plurality of pairs of wells of the microfluidic device 10 as being described under FIG. 1.

The current supply circuit 300 is adapted for selectively activating the first and second electromagnet 310 and 320 in order to generate a magnetic field to the channel entry and exit points 141 and 142.

The control unit (400) is adapted for controlling the function of the analyzer 100 by coordinating the application of the pressure differences and the function of the electromagnets 310 and 320.

In the following a processing of further fluid is described after the first fluid is moved into the fluid channel 140 as above-described under step 1 and step 2 of FIG. 2:

In a third step, the control unit 400 controls the current supply unit 300 to activate the electromagnets 310 and 320 so that the first fluid is locked within the fluid channel 140 by applying a magnetic attractive force to the magnetic beads.

In a fourth step, the second fluid or a sample fluid is processed to flow from the second well 112 through the fluid channel 140. The second fluid interacts with the first fluid such that a first fraction comprising a certain compound of the second fluid is bound by the functional beads of the first fluid being captured by the magnetic force applied to the channel entry and exit 141 and 142 by means of the electromagnets 310 and 320, while the remaining fraction of the fluid might with unwanted compounds pass the fluid channel 149 to the waste 116 or to another well.

In a fifth step, the third fluid or wash fluid is processed from the third well 113 towards the fluid channel 140, wherein the third fluid is chosen to wash further unwanted compounds still being present in first fraction of the second fluid being present in the fluid channel 140, e.g. unwanted compounds being bound to desired compounds of the first fraction of the second fluid. The wash fluid might be water or an alkaline fluid, e.g. having a ph-value of 9 or 10. Alternatively, a saline solution is chosen as wash fluid.

In a sixth, the fourth fluid is processed from the fourth well 114 towards the fluid channel 140 for eluting the desired compounds being bound by the functional beads. This solvent comprising the desired compounds might be driven into a target well, e.g. the seventh well 117 to be removed for further analysis, e.g. by electrophoresis. The removal can be done either manually by the user itself or automatically by a liquid handling module (e.g. by a so-called autosampler unit).

In a more complex chip system the eluted sample might be driven to a further attached section of the microfluidic device 10, e.g. to an electrophoresis section, where an electrophoretic analysis of the eluent is performed within the same microfluidic device.

Additionally, between the fourth step and the fifth step, the supply lines might be emptied by applying appropriate pressure differences corresponding to the second and third pressure difference, e.g. applying further pressure differences between the fifth well (or first air well) and the second well, and the tenth well 120 (second air well) and the waste 116 in order to avoid any mixture of the second and third fluid outside the fluid channel.

Further additionally, between the fifth step and the sixth step, the supply lines might be emptied correspondingly.

After having processed the plurality of further fluids, the electromagnets might be switched off, so that the fluid channel can be emptied from the first fluid, being captured in the fluid channel 140 e.g. by applying a pressure difference so that the first fluid moves back into the first well.

The process described above allows for increasing the concentration of a desired compound comprised in a sample fluid. Further, this process allows for generating a purified solution of the desired compound.

1.-22. (canceled)

23. A method for removing fluid in a microfluidic device, the microfluidic device having a fluid channel, a first well, and a second well, the first well and the second well being coupled to a first end of the fluid channel, the method comprising:
applying a pressure difference between the second well and the first well,
applying a pressure difference between the first end and a second end of the fluid channel being below a certain threshold, for at least partly removing a first fluid from a first supply line coupled between the first well and the first end of the fluid channel.

24. The method of claim 23, comprising at least one of:
the pressure difference applied between the first end and the second end of the fluid channel is substantially zero;
the pressure difference is applied between the first end and the second end of the fluid channel for retaining at least a portion of the first fluid in at least a portion of the fluid channel.

25. The method of claim 23, further comprising:
previously establishing a flow of the first fluid from the first well into the fluid channel.

26. The method of claim 23, further comprising:
applying a magnetic field to at least a part of the fluid channel to force at least a portion of a first fluid to retain in at least a portion of the fluid channel.

27. The method of claim 26, wherein the magnetic field is applied to a region of at least one of: the first and the second end of the fluid channel.

28. The method of claim 26, wherein the magnetic field is applied such that at least a portion of the first fluid will be retained in the fluid channel against external pressure force.

29. The method of claim 23, wherein the first fluid comprises magnetic particles.

30. The method of claim 29, wherein the magnetic particles are adapted to concatenate to each other under an influence of the magnetic field.

31. The method of claim 29, wherein the first fluid comprises at least one of:
magnetic particles having a functionalized surface coating for binding specific molecules;
magnetic particles being suspended with non-magnetic particles having a functionalized surface coating for binding specific molecules.

32. The method of claim 31, the microfluidic device having a first well coupled to a first end of the fluid channel, and a second well coupled to a second end of the fluid channel, comprising:
establishing a flow of the first fluid from the first well over the fluid channel to the second well.

33. The method of claim 32, wherein the flow of the first fluid is established by applying another pressure difference between the first well and the second well.

34. The method of claim 33, wherein the other pressure difference is generated by applying at least one of: a positive pressure with respect to an ambient pressure to the first well, and a negative pressure with respect to the ambient pressure to the second well.

35. The method of claim 23, wherein at least the first supply line and the second supply line are hydrophobic with respect to the first fluid, and wherein the other pressure difference is chosen to exceed a flow resistance imposed by the first and second supply line.

36. The method of claim 23, comprising:
establishing a flow of a second fluid towards the fluid channel having retained a part of the first fluid, wherein the second fluid is adapted to interact with the first fluid such that a first portion of the second fluid is captured by the first fluid within in the fluid channel while a second portion passes the fluid channel.

37. The method of claim 36, further comprising:
establishing a flow of a third fluid towards the fluid channel, wherein the third fluid is adapted to at least partially elute the first portion of the second fluid captured by the first fluid.

38. A software program or product, stored on a data carrier, for controlling the method of claim 23, when run on a data processing system.
